(19) United States
(12) Patent Application Publication
(10) Pub. No.: US 2008/0198166 A1
(43) Pub. Date: Aug. 21, 2008

(54) MULTI-THREADS VERTEX SHADER, GRAPHICS PROCESSING UNIT, AND FLOW CONTROL METHOD

(75) Inventors: Hsine-Chu Chung, Taipei (TW); Chit-Keng Huang, Taipei (TW); Ko-Fang Wang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/675,700

(22) Filed: Feb. 16, 2007

(51) Int. Cl. G06T 1/00

(52) U.S. Cl. 345/501

(57) ABSTRACT

A vertex shader. The vertex shader comprises an instruction register file, a flow controller, a thread arbitrator, and an arithmetic logic unit (ALU) pipe. The instruction register file stores a plurality of instructions. The flow controller concurrently executing a plurality of threads, reads the instructions in order from the instruction register file for the threads and accesses vertex data for the threads. The thread arbitrator checks the dependency of instructions in the threads and selects the thread to execute in accordance with the result of the dependency check and a thread execution priority. The arithmetic logic unit (ALU) pipe receives the vertex data for executing the instructions of the thread selected by the thread arbitrator for three-dimensional (3D) graphics computations.

### BACKGROUND OF THE INVENTION

1. Field of the Invention

The present invention relates to a vertex shader, and more specifically to a vertex shader concurrently executing a plurality of threads.

2. Description of the Related Art

As graphics applications increase in complexity, capabilities of host platforms (including processor speeds, system memory capacity and bandwidth, and multiprocessing) also continually increase. To meet increasing demands for graphics, graphics processing units (GPUs), sometimes also called graphics accelerators, have become an integral component in computer systems. In the present disclosure, the term graphics controller refers to either a GPU or graphic accelerator. In computer systems, GPUs control the display subsystem of a computer such as a personal computer, workstation, personal digital assistant (PDA), or any device with a display monitor.

FIG. 1 is a block diagram of a conventional GPU 10, comprising a vertex shader 12, a setup engine 14, and a pixel shader 16. The vertex shader 12 receives vertex data of images and performs vertex processing which may including transforming, lighting and clipping. The setup engine 14 receives the vertex data from the vertex shader 12 and performs geometry assembly wherein received vertices are re-assembled into triangles. Once each of the triangles creating a 3D scene have been arranged, the pixel shader 16 proceeds to fill them with individual pixels and to perform a rendering process including determining color, depth values, and position on screen with textures for each pixel. The output of the pixel shader 16 can be shown on a display device.

FIG. 2 is a detailed block diagram of the vertex shader 12 shown in the FIG. 1. The vertex shader 12 is a programmable vertex processing unit, performing user-defined operations on received vertex data. The vertex shader 12 comprises an instruction register 22, a flow controller 24, an arithmetic logic unit (ALU) pipe 26, and an input register 28. Basic instructions can be combined into a user-defined program performing operations on vertex data stored in the input register 28. The instructions are stored in the instruction register 22 successively. The flow controller 24 reads the instructions out from the instruction register 22 in order. Meanwhile, the flow controller 24 accesses the vertex data from an input register 28 and determines the dependency among the instructions fetched from the instruction register 22. After the dependency check, the flow controller 24 dispatches the instruction ready for the ALU pipe 26 to perform three-dimensional (3D) graphics computations including source selection, swizzle, multiplication, addition, and destination distribution, wherein the ALU pipe 26 reads the vertex data as necessary from the input register 28.

The instructions stored in the instruction register 22 comprise instructions I0, I1 . . . In. If there is no dependency relation thereamong, the flow controller 24 dispatches the instructions I0. In to the ALU pipe 26 in turn. FIG. 3A shows the order of instructions dispatched to the ALU pipe 26 in each time slot during a period of 4 time slots, T0 to T3, and there is no dependency relation thereamong. However, if the instruction I1 is dependent on instruction I0 as follows:

I₀: Mov TR0 C0;

I₁: Mad OR0 TR0 IR0 C1;

The source TR0 of the instruction I₁ is the destination TR0 of instruction I₀. While instruction I₁ cannot be executed until completion of instruction I₀, bubbles appear in the ALU pipe 26, degrading execution efficiency. Assuming the execution time per instruction endures 4 time slots, FIG. 3B shows instructions dispatched to the ALU pipe 26 in each time slot with a dependency between instructions I0 and I1. Obviously, bubbles appear in time T1˜T3 when there is a dependency between instructions, I₀ and I₁. Thus, it is necessary to solve the above problem for improving the execution efficiency of the conventional vertex shader 12.

### BRIEF SUMMARY OF INVENTION

A detailed description is given in the following embodiments with reference to the accompanying drawings.

The invention is generally directed to a vertex shader concurrently executing a plurality of threads. An exemplary embodiment of a vertex shader comprises an instruction register, a flow controller, a thread arbitrator, and an arithmetic logic unit (ALU) pipe. The instruction register stores a plurality of instructions. The flow controller concurrently executes a plurality of threads and reads the instructions out in order from the instruction register for the threads and accesses vertex data for the threads. The thread arbitrator checks the dependency of instructions in the threads and selects a thread to be executed in accordance with the result of and a thread execution priority. The arithmetic logic unit (ALU) pipe receives the vertex data executing the instruction of the thread selected by the thread arbitrator for three-dimensional (3D) graphics computations.

A graphics processing unit (GPU) is provided. The GPU comprises a vertex shader, a setup engine, and a pixel shader. The vertex shader concurrently executing a plurality of threads, receives image data for coordination, transforming, and lighting. The setup engine assembes the image data received from the vertex shader into triangles. The pixel shader receives the image data from the setup engine, performing a rendering process on the image data to generate pixel data.

A flow control method is also provided. The flow control method for a vertex shader concurrently executing a plurality of threads, comprises reading a plurality of instructions out for the threads, checking the dependency of instructions in the threads, and selecting one thread to execute in accordance with the result of dependency check and a thread execution priority.

### BRIEF DESCRIPTION OF DRAWINGS

The present invention can be more fully understood by reading the subsequent detailed description and examples with references made to the accompanying drawings, wherein:

FIG. 1 is a block diagram of a conventional graphics processing unit (GPU).

FIG. 2 a block diagram of the vertex shader of FIG. 1.

FIG. 3A is a schematic diagram illustrating the order of instructions dispatched to the ALU pipe in FIG. 1, when there is no dependent relation between instructions.

FIG. 3B is a schematic diagram illustrating the order of instructions dispatched to the ALU pipe in FIG. 1, when there is dependent relation between instructions.

FIG. 4 is a block diagram of a vertex shader according to an embodiment of the invention.

FIG. 5 is a block diagram of the vertex shader in FIG. 4, comprising 4 threads.

FIGS. 6A˜6D are a schematic diagram illustrating the order of instructions dispatched to the ALU pipe in FIG. 4.

FIG. 7 is a block diagram of a GPU according to another embodiment of the invention.

FIG. 8 is a flowchart of a flow control method for a vertex shader capable of concurrently executing a plurality of threads according to another embodiment of the invention.

### DETAILED DESCRIPTION OF INVENTION

The following description comprises the best-contemplated mode of carrying out the invention. This description is made for the purpose of illustrating the general principles of the invention and should not be taken in a limiting sense. The scope of the invention is best determined by reference to the appended claims.

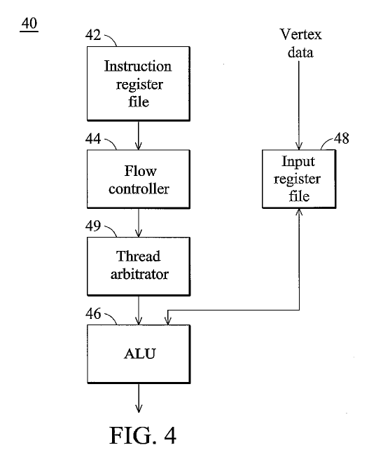

FIG. 4 shows a vertex shader 40 according to an embodiment of the invention. The vertex shader 40 comprises an instruction register file 42, a flow controller 44, an arithmetic logic unit (ALU) pipe 46, an input register file 48 and a thread arbitrator 49. The instruction register file 42 stores instructions of a program, wherein the instructions are stored successively. The input register file 48 stores the vertex data. The flow controller 44 concurrently executing a plurality of threads, reading the instructions out in order from the instruction register file 42 for the executing threads and accesses a plurality of vertex data from the input register file 48 for the executing threads. The thread arbitrator 49 checks the dependency of instructions in the threads and schedules the threads to be executed in accordance with the dependency and a thread execution priority. The arithmetic logic unit (ALU) pipe 46 receives the vertex data from the input register file 48, executes the instruction of the thread selected by the thread arbitrator 49 for three-dimensional (3D) graphics computations, which may include source selection, swizzle, multiplication, addition, and destination distribution.

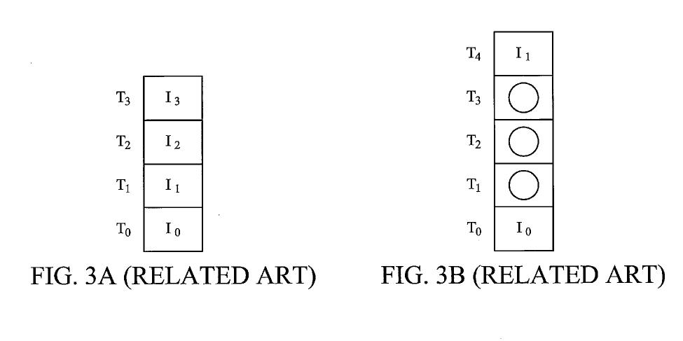

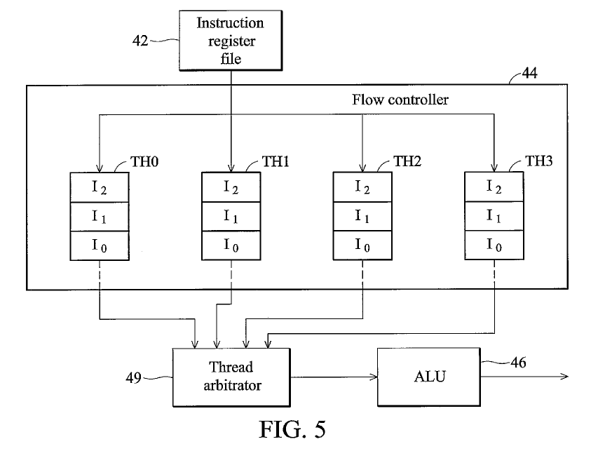

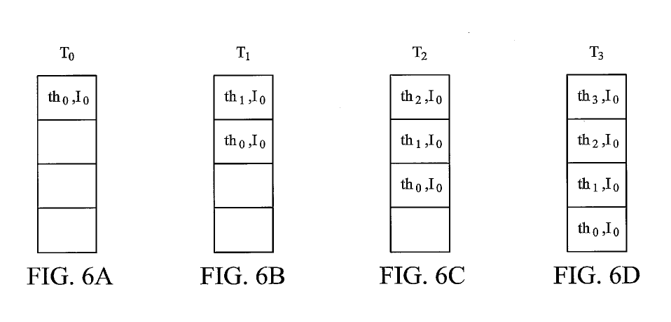

Assuming four threads are provided by the flow controller and a program stored in the instruction register file 42 performing user-defined operations on vertex data includes instruction I₀˜I₂, the instructions I₀˜I₂ for each thread are stored in a corresponding thread register files TH0˜TH3 as shown in FIG. 5. It is noted that each thread in the flow controller 42 executes the same program containing the same instructions I₀˜I₂ and the vertex data is distributed to the thread register files TH0˜TH3 according to the input sequence order of the vertex data. The vertex data VTx0, VTx1, VTx2, and VTx3 may be distributed to the thread register files TH0, TH1, TH2, and TH3, respectively, in one embodiment. To ensure the execution sequence of vertex data, thread execution priority is determined by the thread arbitrator 49 in advance in accordance with the input sequence of vertex data. Thus, when receiving the instructions of threads th0˜th4, the thread arbitrator 49 determines the priority of the threads th0˜th4 at first. In this case, the thread execution priority list is from higher goes to lower as th0 [symbol] th1 [symbol] th2 [symbol] , since the vertex data for threads th0˜th4 are respectively VTx0˜VTx3. Hence the thread arbitrator 49 selects the thread th0 first. Before dispatching the instructions in thread th0 to the ALU pipe 46, the thread arbitrator 49 checks the dependency of the instructions in the thread th0 and finds out there is dependency among the instructions thereof, therefore the thread arbitrator 49 selects a next thread, i.e. th1, for the ALU pipe 46 in accordance with the thread execution priority list, and adjust the thread execution priority as th1 [symbol] th2 [symbol] th3 [symbol] th0. FIGS. 6A to 6D shows the execution order of threads and instructions in the ALU pipe 46 in each time slot when the execution time of per instruction is 4T. As shown in FIG. 6A, the thread arbitrator 49 selects the thread th0 and dispatches the instruction I₀ thereof in time T0, since instructions for each thread are stored in the thread register files in order and there is no instruction dependency in instruction I₀. At time T1, the thread arbitrator 49 is supposed to dispatch I₁ of thread th0 to the ALU pipe 46, however, since the instruction I₁ is dependent on instruction I₀, the arbitrator 49 selects thread th1 according to the thread execution priority list, and dispatches the instruction I₀ of the thread th1 to the ALU pipe 46 as shown in FIG. 6B. Similarly, at time T2, the thread arbitrator 49 selects the thread th2 and dispatches the instruction I₀ of the thread th2 to the ALU pipe 46 as shown in FIG. 6C. At time T3, FIG. 6D shows the execution sequence with respect to the threads and instructions of the ALU pipe 46. Comparing FIGS. 3B with 6D, it is found that the bubbles of FIG. 3B do not occur with the vertex shader 40 of the invention, indicating improved performance of the vertex shader 40.

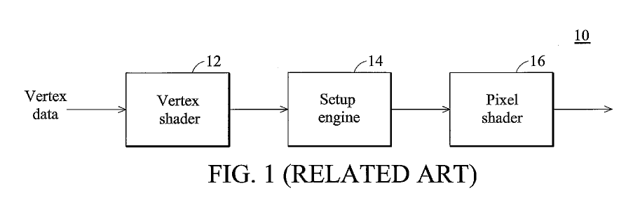

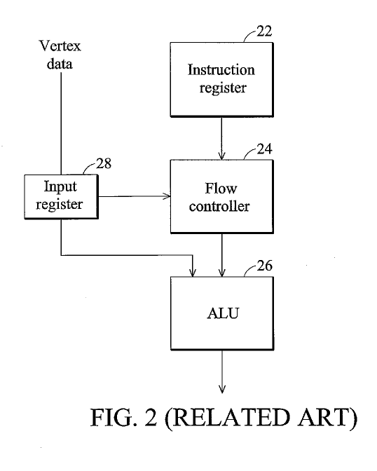

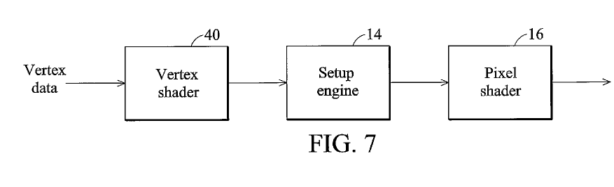

FIG. 7 shows a graphics processing unit (GPU) 70 according to another embodiment of the invention. The GPU 70 is similar to the GPU 10 in FIG. 1 except for the vertex shader 40. FIG. 7 uses the same reference numerals as FIG. 1 which perform the same functions, and thus are not described in further detail. The GPU 70 utilizes the vertex shader 40 of the invention as shown in FIG. 4. The operation of the vertex shader 40 is described previously, and thus is not further described.

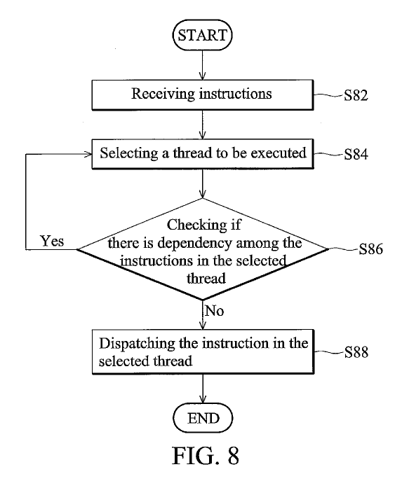

FIG. 8 is a flowchart of a flow control method 800 for a vertex shader concurrently executing a plurality of threads according to an embodiment of the invention. First, a plurality of instructions for executing threads are received (S82), wherein all threads execute the same set of instructions, and the vertex data is distributed to each thread in accordance with the input sequence order of the vertex data. Next, One thread is selected to be executed according to a predetermined priority (S84). Next, the dependency of instructions in the selected thread is checked (S86). If there is dependency among the instructions, the process returns to step S84 to select another thread to be executed according to the predetermined priority. If there is no dependency among the instructions, the instructions in the selected thread is dispatched (S88).

In the invention, a vertex shader concurrently executes a plurality of threads, each on corresponding vertex data. The performance of the ALU pipe in a vertex shader is thus improved, especially when there is dependency of instructions for the vertex shader to execute. As a result, the vertex shader executes instructions of other threads when there is dependency found in instructions of one thread.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vertex shader, comprising:
an instruction register file storing a plurality of instructions;
a flow controller capable of concurrently executing a plurality of threads, reading the instructions in order from the instruction register file for the threads and accessing vertex data for the threads;
a thread arbitrator checking the dependency of instructions in the threads and selecting a thread to execute in accordance with the result of the dependency check and a thread execution priority; and
an arithmetic logic unit (ALU) pipe, receiving the vertex data for executing the instructions of the thread selected by the thread arbitrator.

2. The vertex shader as claimed in claim 1, wherein the flow controller comprises a plurality of thread register files storing the instructions, wherein each thread register file corresponds to one thread.

3. The vertex shader as claimed in claim 1, wherein the thread arbitrator checks the dependency of the instructions in one thread and when there is dependency among the instructions thereof, the thread arbitrator selects a next thread for the ALU pipe in accordance with the thread execution priority.

4. The vertex shader as claimed in claim 1, wherein thread execution priority is determined according to the input sequence order of the vertex data.

5. The vertex shader as claimed in claim 1, wherein the vertex data is distributed to the threads according to the input sequence order of the vertex data.

6. The vertex shader as claimed in claim 1, further comprising an input register file storing the vertex data.

7. The vertex shader as claimed in claim 1, wherein the instructions in the instruction register file are stored successively.

8. The vertex shader as claimed in claim 1, wherein the 3D computations performed by the ALU pipe comprise a combination being selected from a group of:
source selection;
swizzle;
multiplication;
addition; and
destination distribution.

9. A graphics processing unit (GPU) comprising:
a vertex shader concurrently executing a plurality of threads, receiving a plurality of image data for coordination transforming and lighting;
a setup engine assembling the image data received from the vertex shader into triangles; and
a pixel shader receiving the image data from the setup engine and performing a rendering process on the image data to generate pixel data.

10. The graphics processing unit (GPU) as claimed in claim 9, wherein the vertex shader comprises:
an instruction register file storing a plurality of instructions;
a flow controller concurrently executing a plurality of threads, reading the instructions in order from the instruction register file for the threads and accessing the image data for the threads;
a thread arbitrator checking the dependency of instructions in the threads and selecting the thread to execute in accordance with the result of the dependency check and a thread execution priority; and
an arithmetic logic unit (ALU) pipe, receiving the image data for executing the instructions of the thread selected by the thread arbitrator for three-dimensional (3D) graphics computations.

11. The graphics processing unit as claimed in claim 9, wherein the flow controller comprises a plurality of thread register files storing the instructions, wherein each thread register file corresponds to one thread.

12. The graphics processing unit as claimed in claim 9, wherein the thread arbitrator checks the dependency of the instructions in one thread and when there is dependency among the instructions thereof, the thread arbitrator selects a next thread for the ALU pipe in accordance with the thread execution priority.

13. The graphics processing unit as claimed in claim 9, wherein thread execution priority is determined according to the input sequence order of the image data.

14. The graphics processing unit as claimed in claim 9, wherein the vertex data is distributed to the threads according to the input sequence order of the image data.

15. The graphics processing unit as claimed in claim 9, further comprising an input register file storing the image data.

16. The graphics processing unit as claimed in claim 9, wherein the instructions in the instruction register file are stored successively.

17. A flow control method for a vertex shader concurrently executing a plurality of threads, comprising:
reading a plurality of instructions out for the threads;
checking the dependency of instructions in the threads; and
selecting one thread to execute in accordance with the result of the dependency check and a thread execution priority.

18. The flow control method as claimed in claim 17, further comprising dispatching the instructions of the selected thread.

19. The flow control method as claimed in claim 17, wherein selection comprises selecting a next thread in accordance with the thread execution priority when there is dependency among the instructions.

20. The flow control method as claimed in claim 17, wherein thread execution priority is determined according to the input sequence order of the vertex data.

21. The flow control method as claimed in claim 17, further comprising distributing the vertex data to each thread in accordance with the input sequence order of the vertex data.
